(19) United States
(12) Patent Application Publication
(10) Pub. No.: US 2024/0294778 A1
(43) Pub. Date: Sep. 5, 2024

(54) COATING FILM AND COMPONENT PART

(71) Applicant: Mitsubishi Electric Corporation, Tokyo (JP)

(72) Inventors: Yasuhiro YOSHIDA, Tokyo (JP); Natsumi KOYAMA, Tokyo (JP)

(73) Assignee: Mitsubishi Electric Corporation, Tokyo (JP)

(21) Appl. No.: 18/574,333

(22) PCT Filed: Jul. 15, 2021
(86) PCT No.: PCT/JP2021/026605

§ 371 Date: Dec. 27, 2023

(51) Int. Cl. C09D 5/16; C08K 7/18; C09D 7/40; C09D 7/61; C09D 127/12

(52) U.S. Cl. CPC C09D 5/1668; C09D 7/61; C09D 7/67; C09D 7/68; C09D 7/69; C09D 7/70; C09D 127/12; C08K 7/18; C08K 2201/005; C08K 2201/011

(57) ABSTRACT

A coating film includes a water-repellent resin having a smooth surface and a contact angle of 70 degrees or more. The coating film has a plurality of protrusions formed by the water-repellent resin, and the plurality of protrusions are scattered in the coating film and each have an end portion with a convex surface formed by cutting out a continuous region accounting for 50% or more of a spherical surface. The spherical surfaces each have an average radius of curvature of 16 μm or less. An average distance between each ones of the plurality of protrusions adjacent to each other is less than or equal to 30 times a radius of curvature.

### TECHNICAL FIELD

The present disclosure relates to a coating film that imparts water repellency and a component part including the coating film.

### BACKGROUND ART

Super water-repellency is a property of a material that causes water to form water droplets and roll off even when water falls on the material, as known for water droplets on lotus leaves. Many materials having super water-repellency have recently been developed to prevent or reduce attachment of dirt and ice and snow. In general, water-repellent substances having a surface with fine roughness are known as materials having super water-repellency. For dirt resistance, super water-repellent materials can prevent attachment of dirty water, such as mud, and dust attached to super water-repellent materials can be easily released by water washing. However, super water-repellent materials are not effective for, for example, attachment of dust smaller than surface roughness or adsorption of vapor. Substances attached to super water-repellent materials are difficult to be removed because water does not reach the attached substances when the super water-repellent materials are washed with water to remove the attached substances. The use of detergents or solvents changes the roughness of the surface, so that the surface loses its super water-repellency.

Patent Literature 1 discloses a superhydrophobic coating having a polymer binder layer and a plurality of porous protrusions protruding from the surface of the polymer binder layer. In Patent Literature 1, this structure maintains self-cleaning performance even when the coating is immersed in water.

### CITATION LIST

### Patent Literature

Patent Literature 1: Japanese Unexamined Patent Application Publication No. 2009-521551

### SUMMARY OF INVENTION

### Technical Problem

However, the superhydrophobic coating disclosed in Patent Literature 1 uses a porous material to exhibit super water-repellency and thus has the following issue.

The dirt attached to the superhydrophobic coating is difficult to be washed off, and super water-repellency is lost depending on the type of detergent or solvent.

The present disclosure has been made to resolve the above issue and aims at providing a coating film that imparts water repellency and that is easy to be washed and a component part with the coating film.

### Solution to Problem

A coating film of an embodiment of the present disclosure includes a water-repellent resin having a smooth surface and a contact angle of 70 degrees or more. The coating film has a plurality of protrusions formed by the water-repellent resin, and the plurality of protrusions are scattered in the coating film and each have an end portion with a convex surface formed by cutting out a continuous region accounting for 50% or more of a spherical surface. The spherical surfaces each have an average radius of curvature of 16 μm or less. An average distance between each ones of the plurality of protrusions adjacent to each other is less than or equal to 30 times a radius of curvature.

### Advantageous Effects of Invention

According to an embodiment of the present disclosure, the water-repellent resin has a smooth surface, and dirt on the water-repellent resin is easy to be washed off. This provides a coating film that imparts water repellency and that is easy to be washed and a component part with the coating film.

### BRIEF DESCRIPTION OF DRAWINGS

FIG. 1 illustrates a coating film according to Embodiment 1.

FIG. 2 illustrates the super water-repellency exhibited by the coating film according to Embodiment 1.

FIG. 3 illustrates the hydrophilicity exhibited by the coating film according to Embodiment 1.

FIG. 4 illustrates an embodiment of the coating film according to Embodiment 1.

FIG. 5 illustrates an embodiment of the coating film according to Embodiment 1.

FIG. 6 illustrates a coating film according to Embodiment 2.

### DESCRIPTION OF EMBODIMENTS

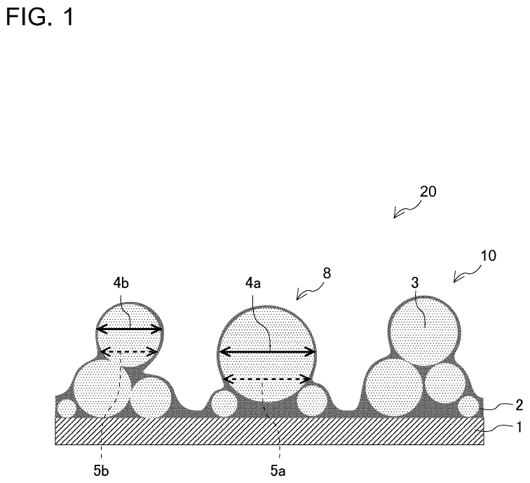

Embodiments of a coating film and a component part according to the present disclosure will be described below with reference to the drawings. The present disclosure is not limited by Embodiments described below. The relationship between the sizes of components in the following drawings including FIG. 1 may be different from the actual one. In the following description, the terms expressing directions are appropriately used for easy understanding of the present disclosure. These terms are used to describe the present disclosure and do not limit the present disclosure. Examples of the terms expressing directions include “upper”, “lower”, “right”, “left”. “front”, and “back”.

### Embodiment 1

FIG. 1 illustrates a coating film 10 according to Embodiment 1. As illustrated in FIG. 1, the coating film 10 includes a water-repellent resin 2 having protrusions 8. A substrate 1 and the coating film 10 form a component part 20. The coating film 10 is formed on the surface of the substrate 1, and the water-repellent resin 2 is exposed on a surface of the coating film 10 opposite the substrate 1. FIG. 1 illustrates a case where the coating film 10 contains spherical particles 3, but the coating film 10 does not necessarily contain the spherical particles 3. On the surface of the coating film 10 opposite the substrate 1, many protrusions 8 are formed, and the water-repellent resin 2 having a smooth surface in the entire area is exposed. The protrusions 8 each have a spherical end portion. Specifically, a convex surface formed by cutting out a continuous region accounting for 50% or more of the spherical surface, that is, a convex surface formed by cutting out an area larger than the hemisphere of the spherical surface, is connected to a base end portion of each protrusion 8.

### (Coating Film 10)

The coating film 10 is formed by stacking the spherical particles of the water-repellent resin 2, applying a coating liquid containing the water-repellent resin 2 and the spherical particles 3, or other methods. In the method of staking the spherical particles of the water-repellent resin 2, the coating film 10 is consisting substantially of the water-repellent resin 2. In the method of applying a coating liquid containing the water-repellent resin 2 and the spherical particles 3, the spherical particles 3 form a skeleton, and the skeleton is coated with the water-repellent resin 2, as illustrated in FIG. 1.

The method of staking the spherical particles of the water-repellent resin 2 involves dispersion liquid coating or powder coating. The coating film 10 is formed by fusing the particles together with a dispersion medium, bonding the particles to each other with a binder, or fusing the particles together with heat. The spherical particles of the water-repellent resin 2 may contain other substances, and the super water-repellent coating film 10 formed by the water-repellent resin 2 having a smooth surface is still obtained.

The method of applying a coating liquid containing the water-repellent resin 2 and the spherical particles 3 enables treatment of various articles only by applying and drying the coating liquid. The shape and surface water repellency of the protrusions 8 can be freely controlled by selecting the water-repellent resin 2 or the spherical particles 3. With regard to the ratio of the spherical particles 3 and the water-repellent resin 2 forming a suited coating film 10, the volume ratio of the spherical particles 3 is preferably 50% or more and 500% or less of the water-repellent resin 2, more preferably 80% or more and 400% or less of the water-repellent resin 2. When the spherical particles 3 are applied at a ratio of less than 50% of the water-repellent resin 2, the spherical particles 3 are buried in the water-repellent resin 2, and many protrusions fail to have a suited shape. When the ratio of the spherical particles 3 is more than 500% of the water-repellent resin 2, it is difficult to form distinct protrusions 8, and the end portions of the protrusions 8 are close to each other at a distance of less than 30 times the radius of curvature, which is not preferred.

The total amount of the water-repellent resin 2 and the spherical particles 3 in the coating liquid is preferably 5 mass % or more and 40 mass % or less, more preferably 8 mass % or more and 25 mass % or less. With the concentration of the total amount is less than 5 mass %, the liquid film before drying easily flows, and it is difficult to uniformly disperse the protrusions 8, which is not preferred. With the concentration of the total amount is more than 40 mass %, the liquid after coating has low fluidity, and it is difficult to form a suited coating film 10. Various solvents that can dissolve the water-repellent resin 2 can be used as a solvent of the coating liquid. Examples of solvents include aromatic hydrocarbon solvents; ketones, such as acetone, methyl ethyl ketone, and MIBK; ethers, such as tetrahydrofuran; esters, such as ethyl lactate, ethyl acetate, and butyl acetate; and N-methylpyrrolidone; naphthenic and paraffinic hydrocarbon solvents; alcohols, such as ethanol and 2-propanol; ethers, such as dimethyl ether and diethyl ether; and various fluororesin solvents.

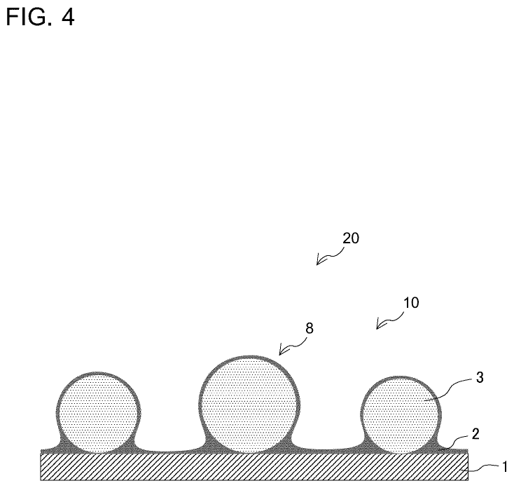

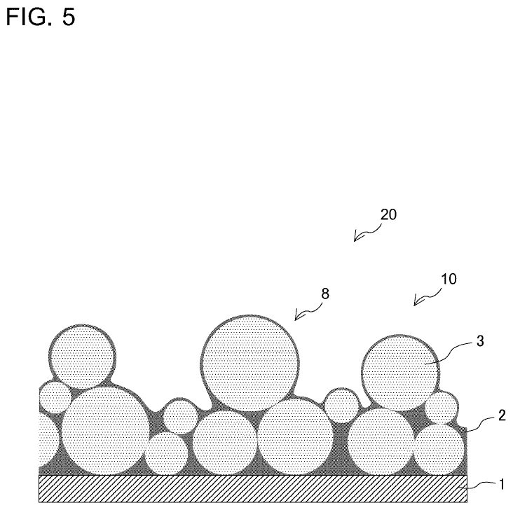

FIG. 4 and FIG. 5 illustrate embodiments of the coating film 10 according to Embodiment 1. Examples of the coating method include brush coating, roller coating, dip coating, screen printing, and spray coating. After a predetermined amount of coating, the coating is dried to form the coating film 10. Various curing agents may be added, followed by heat curing, ultraviolet curing, or other treatments. The thickness and form of the coating film 10 can be adjusted by controlling the coating amount. FIG. 4 illustrates an example of a small coating amount, and FIG. 5 illustrates an example of a large coating amount. In either state, the characteristics of the coating film 10 of Embodiment 1 are obtained. The thin coating film 10 illustrated in FIG. 4 has high transparency and has a small effect on the color of the base. The thick coating film 10 illustrated in FIG. 5 has not only high durability to abrasion or other forms of wear, but also a base protective effect, such as corrosion resistance and weather resistance.

### (Water-Repellent Resin 2)

In the coating film 10, the water-repellent resin 2 for achieving super water-repellency preferably has a contact angle with water 6 of 70 degrees or more, more preferably has a contact angle with the water 6 of 80 degrees or more, in a case where the water-repellent resin 2 has a flat surface. When the contact angle with the water 6 is less than 70 degrees, the coating film 10 fails to have super water-repellency or the coating film 10 is caused to be hydrophilic by a slight stimulus, such as water pressure, even when the coating film 10 has super water-repellency, so that the coating film 10 is not practically used as a super water-repellent coating film. To impart not only super water-repellency but also the property of changing to hydrophilicity, the contact angle with the water 6 is preferably 70 degrees or more and 110 degrees or less, more preferably 80 degrees or more and 100 degrees or less, in a case where the water-repellent resin 2 has a flat surface. When the contact angle with the water 6 is less than 70 degrees, the coating film 10 fails to have super water-repellency, or the coating film 10 is caused to be hydrophilic by a slight stimulus, such as water pressure, even when the coating film 10 has super water-repellency, so that the coating film 10 is not practically used as a super water-repellent coating film. When the contact angle with the water 6 is more than 110 degrees, the coating film 10 cannot be rendered hydrophilic even by spraying the water 6 or injecting the high-pressure water 6.

The water-repellent resin 2 satisfies the water repellency described above. Examples of the water-repellent resin 2 include alkyd resins, epoxy ester resins, urethane resins, acrylic resins, acrylic silicone resins, polyolefin resins, polyvinyl chloride resins, fluororesins, silicone resins, and mixtures of such resins. Fluororesins or silicone resins form a sufficiently high contact angle even when the fluororesins or the silicone resins are used alone. To increase the contact angle with the water 6 by use of other water-repellent resins 2 or to impart water repellency with a contact angle of more than 90 degrees, a fluorine, hydrocarbon, or silicone additive for improving water repellency is only required to be added. Alternatively, a small amount of fine particles may be added. The addition of fine particles can form fine roughness on the surface of the water-repellent resin 2 to improve water repellency.

In this case, any fine particles that can be uniformly mixed with the water-repellent resin 2 can be used regardless of composition. For example, inorganic fine particles, such as fine particles made of silica, alumina, and titania, or fluororesin fine particles, such as fine particles made of PTFE, can be used as fine particles. For inorganic fine particles, the addition of a small amount of inorganic fine particles having the water repellent-treated surface can efficiently improve the water repellency of the resin.

With regard to the particle size of the fine particles, the weight-average particle size measured by laser diffraction particle size distribution analysis is preferably 10 nm or more and 200 nm or less. With regard to the amount of the fine particles added, the weight ratio of the fine particles to the resin component is preferably 50% or less. In this case, the fine particles are dispersed well with treatment with a homogenizer or other devices. When fine particles with an average particle size of more than 200 nm are used, or the amount of the fine particles added is more than 50% in weight ratio, the smoothness of the water-repellent resin 2 is reduced to degrade the durability to friction or contamination, which is not preferred. To make the coating film 10 hydrophilic, there is an issue in which stable hydrophilicity is not obtained even by spraying the water 6 or applying the high-pressure water 6 when the resin has excessively high water repellency or the resin surface has excessively low smoothness. The smoothness of the surface of the water-repellent resin 2 can be determined by use of glossiness as a rough indication. The glossiness of the resin applied onto the flat surface is preferably 70 or more as measured at an angle of incidence of 60 degrees. The resin surface with a glossiness of less than 70 has, as described, an excessive number of pieces in fine roughness, stable hydrophilicity is not obtained in many cases even by spraying the water 6 or applying the high-pressure water 6.

The addition of the fine particles not only has an effect of adjusting the water repellency of the water-repellent resin 2 but also has an effect of easily forming the coating film 10 having super water-repellency. In the coating film 10 having suited super water-repellency, the surface of the spherical particles 3 is coated with a small amount of the water-repellent resin 2. The addition of a small amount of the fine particles to the coating liquid can produce a coating liquid that easily forms the coating film 10 having suited super water-repellency. After application of the coating liquid, the coating liquid is dried in the drying process while the solution of the water-repellent resin 2 flows on the surface of the spherical particles 3. When the amount of the water-repellent resin 2 relative to the amount of the spherical particles 3 is small, the water-repellent resin 2 coating the spherical particles 3 may be too thin at a top portion of each protrusion 8. In this case, there is some area in which the spherical particles 3 are not coated with the water-repellent resin 2, or the water-repellent resin 2 is easily peeled off, which does not result in good super water-repellency. When the fine particles are added to the coating liquid, the solution of the water-repellent resin 2 flowing on the surface of the spherical particles 3 is caused to serve as a pseudoplastic fluid, and the surface of the spherical particles 3 can be coated with a sufficient thickness of the water-repellent resin 2.

The fine particles may be the same as the fine particles used in the case of adjusting water repellency. The amount of the fine particles added may be large in view of fluidity, but needs to be 50% or less in weight ratio from the restrictions from water repellency and surface smoothness. As the fluidity of the coating liquid varies, the suited concentration also slightly changes. The total amount of the water-repellent resin 2 and the spherical particles 3 is preferably 1.5 mass % or more and 30 mass % or less, more preferably 3 mass % or more and 25 mass % or less. With the concentration of the total amount of the water-repellent resin 2 and the spherical particles 3 is less than 1.5 mass %, the liquid film before drying easily flows, and it is difficult to uniformly disperse the protrusions 8, which is not preferred. With the concentration of the total amount of the water-repellent resin 2 and the spherical particles 3 is more than 30 mass %, the liquid after coating has low fluidity, and it is difficult to form a suited coating film 10.

### (Spherical Particle 3)

In the coating film 10, the spherical particles 3 used to achieve super water-repellency preferably have an average particle size of 0.5 μm or more and 30 μm or less, more preferably have an average particle size of 0.5 μm or more and 15 μm or less. The average particle size in this case refers to the weight-average particle size. When the average particle size is less than 0.5 μm, the protrusions 8 with a suited shape are not formed by coating the spherical particles 3 with a sufficient thickness of the water-repellent resin 2. The use of the particles with an average particle size of more than 30 μm fails to provide super water-repellency. The spherical particles 3 used to achieve hydrophilicity in addition to super water-repellency, the average particle size is preferably 1 μm or more and 30 μm or less, more preferably 1.8 μm or more and 15 μm or less. The average particle size in this case refers to the weight-average particle size. When the average particle size is less than 1 μm, the gaps between the formed protrusions 8 are small, and the depth is also shallow, so that it is difficult to obtain stable hydrophilicity. The use of the particles with an average particle size of more than 30 μm fails to provide super water-repellency.

The spherical particles 3 may be spherical inorganic particles. The spherical particles 3 are preferably made of fused silica, fused alumina, or other materials. The spherical particles 3 preferably have a dense composition, which is solid but not porous. Inorganic particles have an advantage that the film has high strength. The spherical particles 3 may be spherical resin particles. The spherical particles 3 may be made of various resins, such as methacrylic resin, polystyrene, silicone, and phenolic resin. The use of resin particles has an advantage that the film has high flexibility and hardly has defects, such as peeling, and the spherical particles 3 are less likely to settle as the coating composition and easy to be used. The spherical particles 3 having corners and projections are not preferred because many protrusions 8 do not each form a suited spherical surface.

### (Super Water-Repellency)

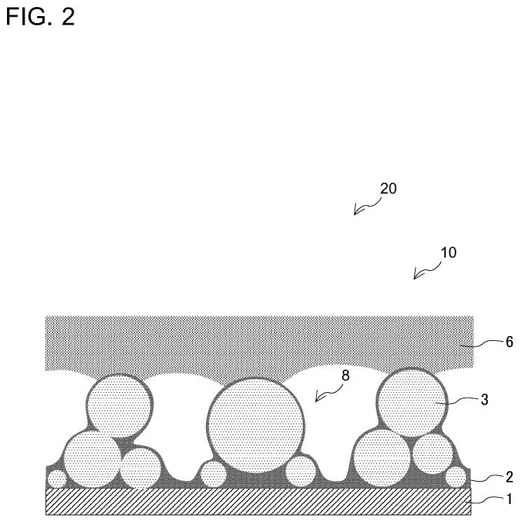

FIG. 2 illustrates the super water-repellency exhibited by the coating film 10 according to Embodiment 1. FIG. 2 illustrates the surface of the super water-repellent coating film 10 in contact with the water 6 when the coating film 10 is immersed in the water 6 or exposed to running water or water droplets. As illustrated in FIG. 2, the water 6 is in contact with only the spherical surfaces located on the tops of the protrusions 8, and the water 6 does not enter the gaps between the protrusions 8. This state is caused because the contact area is the spherical convex surface formed by the water-repellent resin 2 having water repellency. The interface between air and the water 6 not in contact with the protrusions 8 has concave surfaces recessed on the water side. The water 6 is stable because of its low surface free energy. To fill the gaps between the protrusions 8 with the water 6, it is necessary to apply water pressure such that the interface between the water 6 and air has convex surfaces when the interface is viewed from the air side. The coating film 10 in contact with the water 6 is thus stable with a very small contact area. When the top of each protrusion 8 does not have a spherical convex surface but has a corner or a flat surface, the water 6 easily enters the gaps between the protrusions 8, so that the coating film 10 is no longer super water-repellent.

Since the top of each protrusion 8 in the coating film 10 has a spherical convex surface, it is very easy to release the water 6 attached to the coating film 10. This is because, in the release of the water 6 in contact with the spherical convex surface, the water 6 is smoothly released without a large change in the contact state between the water 6 and the water-repellent resin 2, and finally detached such that the contact area becomes small at the top portion. When the top of each protrusion 8 does not have a spherical convex surface but has roughness or a flat surface, the water 6 is not released smoothly, and water droplets or a water film tends to remain. When the spherical convex surface is formed by cutting out a continuous region accounting for 50% or more of the spherical surface and has a large area, suited releasability of the water 6 is achieved. When the spherical convex surface is a continuous region accounting for less than 50% of the area of the spherical surface, a large amount of the water 6 is in contact with the flat portion or the concave portion, the releasability of the water 6 is degraded, which is not preferred. The cut-out continuous region of the spherical surface preferably includes a hemisphere surface. The spherical convex surface is more preferably a convex surface formed by cutting out a continuous region accounting for 70% or more of the spherical surface.

Super water-repellency can be more certainly obtained by controlling the horizontal cross-sectional area of the protrusions 8. The term horizontal in this case refers to a plane parallel to the surface of the substrate 1. The horizontal cross-sectional area of the end portion of each protrusion 8 preferably has a maximum possible value. In FIG. 1, there are maximum portions 4a and 4b with the maximum possible horizontal cross-sectional area in the end portions of the protrusions 8. In the middle portions of the protrusions 8, there are minimum portions 5a and 5b with the minimum possible horizontal cross-sectional area corresponding to the maximum portions 4a and 4b. When the water 6 is in contact with the surface of the coating film 10 under water pressure, the water 6 is forced into the gaps between the protrusions 8. The shape having the maximum portions 4a and 4b with the maximum possible horizontal cross-sectional area in the end portions, that is, the constricted shape, makes it difficult for the water 6 to enter the gaps between the protrusions 8 even under water pressure. This structure can maintain suited releasability of the water 6, that is, super water-repellency.

Common super water-repellent materials have a large contact angle with the water 6 of more than 150 degrees when fine roughness of less than 1 μm is formed on the surface by adding fine particles to the materials or making the materials porous. The super water-repellency of the coating film 10 of Embodiment 1 is achieved in a way completely different form that for super water-repellency attributed to fine roughness known in the related art, as described above. The surface having super water-repellency attributed to fine roughness easily loses its super water-repellency because of stimulus, such as friction, and attachment of fine dust, oily substances, surfactants, or other substances, or other factors. The coating film 10 of Embodiment 1, however, does not have such a disadvantage because the coating film 10 is formed by the smooth water-repellent resin 2.

In Embodiment 1, the super water-repellency of the coating film 10 is achieved by the end portions of the protrusions 8 having a spherical convex surface. The average radius of curvature of the spherical surfaces at the end portions of the protrusions 8 is preferably 16 μm or less, more preferably 8 μm or less. When the average radius of curvature is more than 16 μm, the coating film 10 easily loses its super water-repellency because of the flow of the water 6 or other factors and has poor practicality. The average distance between the protrusions 8 adjacent to each other is preferably less than or equal to 30 times the radius of curvature, more preferably less than or equal to 20 times the radius of curvature. The average distance between the protrusions 8 is an average distance between the tops of the protrusions 8 located closest to each other. When the average distance is more than 30 times the radius of curvature, the coating film 10 easily loses its super water-repellency because of the flow of water or other factors and has poor practicality.

### (Hydrophilicity)

The coating film 10 has super water-repellency on the smooth surface without fine roughness. Furthermore, the property of changing to hydrophilicity under specific conditions while super water-repellency imparted to the coating film 10 is maintained by devising the shape of the protrusions 8 and the water repellency of the water-repellent resin 2. Conversion between super water-repellency and hydrophilicity or compatibility between super water-repellency and hydrophilicity is achieved by controlling the amount of the water 6 entering the gaps between the protrusions 8. The coating film 10 is designed such that normal water droplets or running water cannot enter the gaps between the protrusions 8 and fine water droplets or high-pressure water 6 can enter the gaps between the protrusions 8. The coating film 10 is super water-repellent when the water 6 does not enter the gaps between the protrusions 8, or hydrophilic when the water 6 enters the gaps between the protrusions 8.

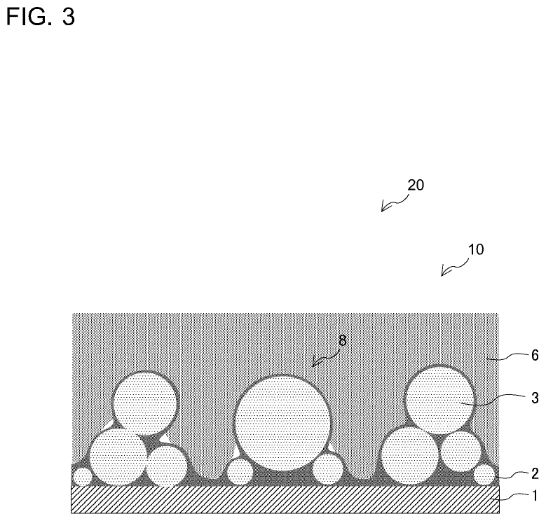

FIG. 3 illustrates the hydrophilicity exhibited by the coating film 10 according to Embodiment 1. As illustrated in FIG. 3, the coating film 10 is hydrophilic when the gaps between the protrusions 8 are filled with the water 6. When the gaps between the protrusions 8 have an appropriate size, large water droplets cannot enter the gaps between the protrusions 8, and fine water droplets or high-pressure water 6 can enter the gaps between the protrusions 8. Once the water 6 enters the gaps between the protrusions 8 and fills the gaps, the water 6 is stabilized in contact with the concave surfaces on the surface of the water-repellent resin 2 and less likely to escape. The water 6 held in the gaps between the protrusions 8 has an effect of retaining the water 6 in contact with the coating film 10, and the coating film 10 is thus a stable wet film although the coating film 10 is formed by the water-repellent resin 2.

Since the top portions of the protrusions 8 each have a shape with a spherical convex surface, the gaps between the protrusions 8 widen from upper layer portions of the coating film 10 toward inside. The water 6 filling the gaps is stable and less likely to escape compared with a case where the gaps are simple recesses or holes. As in the case of exhibiting super water-repellency, the hydrophilic effect can be more certainly obtained by controlling the horizontal cross-sectional area of the protrusions 8. The term horizontal in this case refers to a plane parallel to the surface of the substrate 1. The horizontal cross-sectional area of the end portion of each protrusion 8 preferably has a maximum possible value.

In FIG. 1, there are maximum portions 4a and 4b with the maximum possible horizontal cross-sectional area in the end portions of the protrusions 8. In the middle portions of the protrusions 8, there are minimum portions 5a and 5b with the minimum possible horizontal cross-sectional area corresponding to the maximum portions 4a and 4b. This structure forms a shape that allows the water 6 to spread inside. Accordingly, the hydrophilicity indicating difficulty in escaping of the filled water 6 can be achieved more assuredly. The gaps between the protrusions 8 in the coating film 10 are defined by the water-repellent resin 2 having a smooth surface. When the water 6 escapes from the gaps between the protrusions 8, air needs to enter instead, but there is no path for air to enter because of close contact between the water 6 and the water-repellent resin 2 at the interface. The water 6 is thus less likely to escape.

As described above, common super water-repellent materials have a large contact angle with the water 6 of more than 150 degrees when fine roughness of less than 1 μm is formed on the surface of a water-repellent source material. Such materials are not hydrophilic even when the materials have a structure having the protrusions 8 as in the coating film 10 of Embodiment 1. Since the surface is super water-repellent, the water 6 does not come into close contact with the inside of the gaps between the protrusions 8 even when the water 6 is forced into the gaps between the protrusions 8, and the water 6 is naturally discharged to the outside by the surface tension of the water 6. Another reason why the water 6 is easily discharged is that the water 6 does not come into close contact with the super water-repellent surface, and the air layer formed at the interface serves as an air path in discharging the water 6. Since the coating film 10 has the surface formed by the smooth water-repellent resin 2, the coating film 10 of Embodiment 1 can also exhibit hydrophilicity.

To make the coating film 10 of Embodiment 1 exhibit hydrophilicity, it is necessary to further limit the conditions for exhibiting super water-repellency described below in Example 1. More specifically, the average radius of curvature of the spherical surfaces at the end portions of the protrusions 8 is preferably 0.6 μm or more and 16 μm or less, more preferably 1 μm or more and 8 μm or less. When the average radius of curvature is more than 16 μm, it is difficult to maintain super water-repellency, and the coating film 10 has poor practicality. When the average radius of curvature is less than 0.6 μm, the gaps are so small that stable hydrophilicity is difficult to be obtained even by spraying the water 6 or applying the high-pressure water 6, which is not preferred.

The average distance between the protrusions 8 adjacent to each other is preferably from 4 times to 30 times the radius of curvature, more preferably from 6 times to 20 times the radius of curvature. The average distance between the protrusions 8 is an average distance between the tops of the protrusions 8 located closest to each other. When the average distance is more than 30 times the radius of curvature, the coating film 10 easily loses its super water-repellency because of the flow of water or other factors and has poor practicality. When the average distance is less than 4 times the radius of curvature, the gaps between the protrusions 8 are so small that hydrophilicity is difficult to be obtained even by spraying the water 6 or applying the high-pressure water 6, which is not preferred.

### (Cleaning Performance)

When the coating film 10 is in a hydrophilic state, the water 6 comes into close contact with the surface of the water-repellent resin 2. The dirt attached to the surface of the water-repellent resin 2 can be washed with the water 6. Attached substances that are not dissolved in the water 6 can be washed by use of the water 6 containing a solvent or a surfactant. Since common super water-repellent materials have a surface with fine roughness, the exposure of super water-repellent materials to a solvent or a surfactant damages the fine structure or causes the solvent or the surfactant to enter the recesses of the fine roughness. As a result, the solvent or the surfactant is difficult to be removed, and the super water-repellency is lost. Since the coating film 10 of Embodiment 1 is formed by the surface of the smooth water-repellent resin 2, the coating film 10 of Embodiment 1 can be washed, which is difficult for common super water-repellent materials.

The super water-repellent coating film 10, which is a wet film formed by filling the gaps between the protrusions 8 with the water 6, recovers its super water-repellency when the water 6 is dried. Short-time drying can be achieved by removing the water 6 other than the water 6 in the gaps by wiping or air blow. In particular, the use of air blow promotes blowing-off of the water 6 and evaporation of the water 6 in the gaps to readily recover super water-repellency. When the water 6 forming the wet film contains hydrophilic impurities, the hydrophilic impurities remain on the super water-repellent coating film 10 after drying, and the coating film 10 may lose its super water-repellency. During drying, the residual impurities can be retained inside the gaps by removing the water 6 other than the water 6 in the gaps, which can prevent or reduce degradation in super water-repellency. The coating film 10 of Embodiment 1 has suited cleaning performance.

### (Drug Sustained Release Effect)

The super water-repellent coating film 10 of Embodiment 1 also has an effect of sustained release of a contained drug when the coating film 10 becomes hydrophilic. The super water-repellent surface, which repels the water 6, is used to prevent or reduce attachment of microorganisms and maintain hygienic conditions. In an attempt to perform sustained release of antibacterial agents, antiviral agents, or other agents to obtain high hygienic conditions, almost no water 6 comes into contact with the super water-repellent surface, which causes a problem of difficulty of sustained release of such agents. Common super water-repellent materials, when it is mixed with other drugs, such as antibacterial agents and antiviral agents, also have a problem of degradation in super water-repellency itself. The coating film 10 of Embodiment 1 allows the water 6 to be in close contact with the surface of the coating film 10 and thus enables sustained release of drugs. Since the water-repellent resin 2 used here is not super water-repellent, the water-repellent resin 2 can be mixed with various hydrophilic or water-repellent drugs.

### Embodiment 2

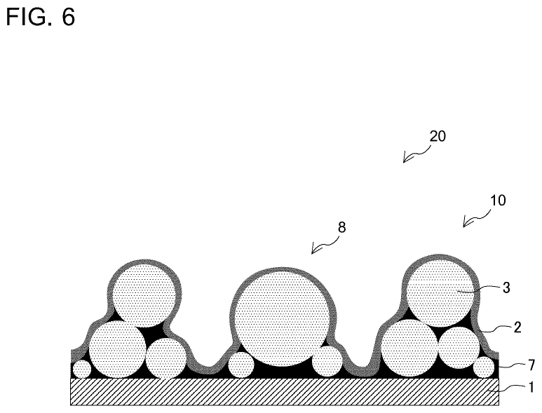

FIG. 6 illustrates a coating film 10 according to Embodiment 2. Embodiment 2 is different from Embodiment 1 in that the coating film 10 includes a binding agent 7. In Embodiment 2, the parts common to Embodiments 1 and 2 are denoted by the same reference signs, and description of the common parts is omitted. The different points from Embodiment 1 will be mainly described.

As illustrated in FIG. 6, the spherical particles 3 are adhered to each other by the binding agent 7, and the spherical particles 3 are adhered to the substrate 1 by the binding agent 7. In other words, the coating film 10 has a structure in which the surfaces of the binding agent 7 and the spherical particles 3 are coated with the water-repellent resin 2. The spherical particles 3 may be bonded by use of the water-repellent resin 2 as illustrated in FIG. 1. However, the water-repellent resin is less likely to increase the strength, and there is a limit to improvement in the strength of the formed super water-repellent coating film 10 having such a structure. When the spherical particles 3 are bonded by use of the binding agent 7 having high strength, and the surface of the spherical particles 3 is covered with the water-repellent resin 2, the super water-repellent coating film 10 can have both strength and surface water-repellency.

### (Binding Agent 7)

The binding agent 7 has a strength when the binding agent 7 is in close contact with the spherical particles 3 and the substrate 1. The binding agent 7 needs to be able to be applied as a coating agent. For example, alkyd resins, epoxy ester resins, urethane resins, acrylic resins, acrylic silicone resins, polyolefin resins, polyvinyl chloride resins, fluororesins, and silicone resins are preferred because these resins can be used regardless of water repellency or hydrophilicity and are easily handled as a coating agent.

Polycarbonate, nylon, polyethylene terephthalate, polybutylene terephthalate, polyphenylsulfone, polysulfone, polyarylate, polyetherimide, polyethersulfone, polysulfone, and polyvinylidene fluoride, or other resins are preferred because these resins have high strength and heat resistance. A cross-linking agent for improving strength, a coupling agent for improving close contact, or other agents are also preferably added. Phenolic resins, urea resins, melamine resins, epoxy resins, unsaturated polyester resins, polyurethane resins, diallyl phthalate resins, silicone resins, and other curable resins can also be used and preferred since these curable resins tend to improve strength.

An inorganic binding agent 7, such as silica and titania, is preferred to improve film strength and heat resistance. Metal alkoxides, polysilazanes, or other substances can be used. In particular, inorganic binding agents prepared by a sol-gel method that uses silicon or titanium alkoxide are preferred because these inorganic binding agents are easy to be handled and easily provide close contact and strength. The addition of fine particles made of silica, alumina, titania, or other materials into the binding agent 7 reduces or prevents cracking or forms a suited shape after curing the binding agent 7.

The coating film 10 of Embodiment 2 is formed by a step of forming an undercoat layer including the spherical particles 3 and the binding agent 7 and a step of applying the water-repellent resin 2. The undercoat layer is formed by applying a coating liquid containing the spherical particles 3 and the binding agent 7. The binding agent 7 may be dissolved in the coating liquid or dispersed as fine liquid droplets or solid particles. With regard to the ratio of the spherical particles 3 and the binding agent 7 in the coating liquid for the undercoat layer, the volume ratio of the spherical particles 3 is preferably 80% or more and 600% or less of the binding agent 7, more preferably 100% or more and 500% or less of the binding agent 7.

In this case, the volume of the binding agent 7 is the volume after curing by drying or heating. When the spherical particles 3 are applied at a ratio of less than 80% of the binding agent 7, the spherical particles 3 are buried in the water-repellent resin 2 after the water-repellent resin 2 is over-coated with the water-repellent resin 2, and many protrusions fail to have a suited shape, which is not preferred. When the ratio of the spherical particles 3 is more than 600% of the binding agent 7, the coating film 10 fails to have enough strength.

The total amount of the water-repellent resin 2 and the binding agent 7 in the coating liquid for the undercoat layer is preferably 30 mass % or less, more preferably 15 mass % or less. In this case, the mass of the binding agent 7 is the mass after curing by drying or heating. When the total amount is more than 30 mass %, the liquid after coating has low fluidity, and it is difficult to form a suited coating film 10. In coating with the undercoat layer, only drying a coating liquid in which the binding agent 7 dissolved provides such a suited form in which a meniscus is formed between the spherical particles 3 so that the spherical particles 3 are bonded to each other. When the binding agent 7 is contained as solid particles or contains the fine particles, it is necessary to increase the density of the binding agent 7 or form a meniscus by heating after coating.

The coating with the water-repellent resin 2 is performed by applying a coating liquid containing the water-repellent resin 2. The water-repellent resin 2 used here may be the same as the water-repellent resin 2 of Embodiment 1, and may be mixed with fine particles. The solvent is any solvent that does not dissolve or degrade the binding agent 7, and selected form the solvents described in Embodiment 1 and used. The concentration of the water-repellent resin 2 in the coating liquid is preferably 0.1 mass % or more and 20 mass % or less, more preferably 0.5 mass % or more and 10 mass % or less. When the concentration is less than 0.1 mass %, the coating film 10 having a sufficient amount of the water-repellent resin 2 is not formed on the top portions of the protrusions 8, and the coating film 10 fails to have super water-repellency, or is easily degraded by friction or other causes, which is not preferred. When the concentration is more than 20 mass %, the gaps between the protrusions 8 are filled with the water-repellent resin 2, and the coating film 10 fails to have super water-repellency, or cannot be rendered hydrophilic even by spraying the water 6 or applying the high-pressure water 6, which is not preferred.

In the coating film 10 of Embodiment 2, the spherical particles 3 are bonded by use of the binding agent 7. This structure can not only increase the strength of the coating film 10 but also reduce the amount of the water-repellent resin 2 used. This structure also has an advantage in cost reduction in the case of using an expensive material as the water-repellent resin 2. The coating with the undercoat layer can be performed by use of brush coating, roller coating, dip coating, screen printing, spray coating, or other methods as in Embodiment 1. The coating film 10 as illustrated in FIG. 4 and FIG. 5 is thus formed. In this case, the surfaces of the spherical particles 3 are not necessarily coated with the resin. The application of the water-repellent resin 2 involves only forming a thin film by use of a low-concentration coating liquid, and the effect of coating unevenness caused by changes in coating film thickness is thus less problematic, and the water-repellent resin 2 can be applied by a simple work.

Since Embodiment 2 has an advantage of easy application of the water-repellent resin 2 as described above, the water-repellent resin 2 can be used in a repair work when the coating film 10 is degraded. The coating film 10 of Embodiment 2 has a pollution control or cleaning effect, but the surface of the coating film 10 may degrade over a long period of time. In this case, the performance can be recovered by applying the water-repellent resin 2 again. In addition, coating unevenness or other defects are less likely to be caused, and the coating film on articles placed outdoors or other articles can be easily repaired. The method for repairing the coating film 10 by application of the water-repellent resin 2 can be used for the coating film 10 of Embodiment 1. In this case, for example, solvents used in curing and repairing the coating film 10 need to be selected to prevent degradation in the coating film 10 caused by solvents during application of the water-repellent resin 2.

### Embodiment 3

Embodiment 3 describes a case where the coating films 10 of Embodiments 1 and 2 are applied to articles having a heating mechanism. In this case, the effect of preventing or reducing attachment of ice and snow or frost and the effect of melting ice and snow or frost with heat can both be obtained. The heated super water-repellent coating film 10 has a great effect of preventing or reducing attachment of colliding water 6 or ice and snow caused by raining, snowing, or other weather conditions. When the coating film 10 is placed in contact with the water 6 or ice and snow, the super water-repellent coating film 10 is hydrophilic and can efficiently melt ice and snow.

The water 6 in contact with the heated coating film 10 increases in temperature and decreases in surface tension and viscosity. The coating film 10 of Embodiment 3 has the function of becoming hydrophilic when the water 6 enters the gaps between the protrusions. A spray of the water 6 or the high-pressure water 6 enters the gaps, but the water 6 having the surface tension and viscosity reduced by increasing temperature enters the gaps only upon contact with the surface of the coating film 10, so that the coating film 10 becomes hydrophilic. In conditions in which the coating film 10 is exposed to rain or snow, the water 6 does not increase in temperature and does not enter the gaps, and the attachment preventing effect with high super water-repellency is maintained. In conditions in which the coating film 10 is in contact with snow or ice, the heated water 6 is generated on the surface of the super water-repellent coating film 10, and the surface of the coating film 10 turns hydrophilic.

To obtain this effect, the temperature of the super water-repellent coating film 10 is 30 degrees C. or higher and 100 degrees C. or lower, more preferably 60 degrees C. or higher and 90 degrees C. or lower. When the temperature is lower than 30 degrees C., the coating film 10 may not become hydrophilic. When the temperature is higher than 100 degrees C., the coating film 10 becomes hydrophilic instead of super water-repellent, and the effect of preventing or reducing attachment of ice and snow is not obtained. A typical super water-repellent surface may also have the effect of preventing or reducing attachment of ice and snow or frost and accelerating release of ice and snow or frost. Ice and snow or frost is not attached to the super water-repellent surface and easily released from the super water-repellent surface. The super water-repellent surface does not have the function of melting the released ice and snow or frost and does not efficiently melt the released ice and snow or frost even when the super water-repellent surface is heated with a heater or other heating device because the ice and snow or frost is not in close contact with the super water-repellent surface.

In the related art, the surface layer containing silicone and a water-repellent fluororesin is known to have high cleaning performance with running water. The super water-repellent surface can prevent or reduce attachment of ice and snow but does not dissolve ice and snow, and it is necessary to remove ice and snow. In this case, a method of melting ice and snow by heating the surface with a heater is commonly used. However, for example, melting ice and snow by use of a heater has an issue of low melting efficiency because an air layer is present between ice and the super water-repellent surface and serves as an insulating layer. The coating film 10 of Embodiment 3 resolves this issue.

### EXAMPLES

Embodiments 1 to 3 will be specifically described below with reference to Examples, but Embodiments 1 to 3 are not limited to Examples described below.

### Examples 1 and 2 and Comparative Examples 1 to 5

Lumiflon LF800 (available from AGC Inc.) was used as the water-repellent resin 2, and QSG-170 (available from Shin-Etsu Chemical Co., Ltd.), and FB5D, FB15D, and FB40R (Denka Company Limited) were used as the spherical particles 3. A coating liquid with the concentration of 20 mass % of the water-repellent resin 2 and the spherical particles 3 in Mineral Spirits solvent was prepared, applied onto a glass plate by spraying, and dried for about 1 hour. The coating film after drying was then observed with an optical microscope and measured for contact angle. Subsequently, the water 6 was sprayed with a pump sprayer for about 15 seconds, and the attachment state of the water 6 was observed. It is noted that the contact angle of the coating film 10 consisting of the water-repellent resin 2 was 82 degrees.

TABLE 1

| | Average | | Amount | | | | |
|---|---|---|---|---|---|---|---|
| | Particle | | of | | | | |
| | Size of | | Spherical | | | After | |
| | Spherical | | Particles | Shape of | Contact | Spraying | |
| | Particles | | Added* | Protrusions | Angle | Water | Note |
| Comparative | 0.17 | μm | 200 | Protrusions | 152 | Water- | Excessively small |
| Example 1 | | | mass % | of 0.5 μm | degrees | repellent | protrusions |
| | | | | or less | | surface | Spherical particles |
| | | | | | | | with excessively |
| | | | | | | | small particle size |
| Comparative | 5 | μm | 40 | No | 86 | Water- | No protrusions |
| Example 2 | | | mass % | protrusions | degrees | repellent | formed |
| | | | | formed | | surface | Insufficient amount |
| | | | | | | | of spherical |
| | | | | | | | particles added |
| Example 1 | 5 | μm | 200 | Good | 151 | Wet | |
| | | | mass % | | degrees | surface | |
| Comparative | 5 | μm | 600 | No | 140 | Water- | No protrusions |
| Example 3 | | | mass % | independent | degrees | repellent | formed |
| | | | | protrusions | | surface | Excessive amount |
| | | | | | | | of spherical |
| | | | | | | | particles added |
| Comparative | 15 | μm | 40 | No | 75 | Water- | No protrusions |
| Example 4 | | | mass % | protrusions | degrees | repellent | formed |
| | | | | formed | | surface | Insufficient amount |
| | | | | | | | of spherical |
| | | | | | | | particles added |
| Example 2 | 15 | μm | 150 | Good | 143 | Water- | |
| | | | mass % | | degrees | repellent | |
| | | | | | | surface | |
| Comparative | 40 | μm | 100 | Large | 97 | Water- | Excessively large |
| Example 5 | | | mass % | protrusions | degrees | repellent | protrusions |
| | | | | | | surface | Spherical particles |
| | | | | | | | with excessively |
| | | | | | | | large particle size |

*The volume ratio to the water-repellent resin

In Examples 1 and 2, the shape of the end portion of each protrusion 8 has a convex surface formed by cutting out a continuous region accounting for 50% or more of the spherical surface. The spherical surfaces have an average radius of curvature of 16 μm or less. The average distance between the protrusions 8 adjacent to each other is less than or equal to 30 times the radius of curvature. The surface of the coating film 10 is formed by the water-repellent resin 2 having a smooth surface and a contact angle of 70 degrees or more, and the coating film 10 has super water-repellency. The formation of the protrusions 8 including the spherical particles 3 stacked on top of each other can be observed with an optical microscope. In both Examples 1 and 2, the contact angle is more than 140 degrees, and the sliding angle not shown in Table 1 is 2 degrees or less, which indicates Examples 1 and 2 both have high super water-repellency. It is observed that the surface of the coating film 10 after spraying the water 6 becomes a wet surface and turns hydrophilic, and the surface of the coating film 10 after drying the water 6 becomes super water-repellent again. Spraying the water 6 from a high-pressure washer instead of an atomizer also provides a hydrophilic surface similarly.

In Comparative Example 1, the spherical particles 3 are small, and the protrusions 8 are small and close to each other. In other words, Comparative Example 1 fails to satisfy the requirement that the spherical surfaces have an average radius of curvature of 16 μm or less. The coating film had super water-repellency, but after spraying the water 6 with an atomizer or high-pressure washer, the coating film was not hydrophilic although water droplets were attached to the coating film. In Comparative Examples 2 and 4, the amount of the spherical particles 3 added is too small. In other words, Comparative Examples 2 and 4 fail to satisfy the requirement that the shape of the end portion of each protrusion 8 has a convex surface formed by cutting out a continuous region accounting for 50% or more of the spherical surface. The spherical particles 3 form convex portions on the film surface, but the convex portions do not protrude enough. Thus, the coating film is not super water-repellent, and is not hydrophilic after spraying the water 6.

In Comparative Example 3, the amount of the spherical particles 3 added is too large. The coating film 10 including stacked spherical particles 3 is formed, and no independent protrusions 8 are formed. In other words, Comparative Example 3 fails to satisfy the requirement that the shape of the end portion of each protrusion 8 has a convex surface formed by cutting out a continuous region accounting for 50% or more of the spherical surface. Although the protrusions 8 are formed, the spherical particles 3 are not coated with a sufficient amount of the water-repellent resin 2, which does not result in good super water-repellency. There are no gaps left between the protrusions 8, and no wet surface is formed even after spraying the water 6. In Comparative Example 5, the spherical particles 3 are too large. In other words, Comparative Example 5 fails to satisfy the requirement that the spherical surfaces have an average radius of curvature of 16 μm or less. The coating film is thus not super water-repellent, and is not hydrophilic after spraying the water 6.

### Examples 3 and 4 and Comparative Examples 6 to 8

The same test as in Example 1 was carried out by use of coating liquids containing fine particles and having various coating liquid concentrations by use of the same water-repellent resin 2 and the same spherical particles 3 as in Example 1. Aerosil 200 (available from Nippon Aerosil Co., Ltd.) was used as the fine particles. The average particle size of the dispersed fine particles was 80 nm.

TABLE 2

| | | Amount | | | | |
|---|---|---|---|---|---|---|
| | | of | | | | |
| | Concentration | Spherical | | | After | |
| | of Coating | Particles | Shape of | Contact | Spraying | |
| | Liquid* | Added** | Protrusions | Angle | Water | Note |
| Comparative | 2.5 | None | Moderate | 85 | Water- | Liquid with low |
| Example 6 | mass % | | | degrees | repellent | concentration |
| | | | | | surface | |
| Example 1 | 20 | None | Good | 151 | Wet | |
| | mass % | | | degrees | surface | |
| Comparative | 50 | None | Uneven | 120 | Partially | Liquid with |
| Example 7 | mass % | | | degrees | water- | high |
| | | | | | repellent | concentration |
| | | | | | surface | |
| Example 3 | 2.5 | 20 | Good | 148 | Wet | |
| | mass % | mass % | | degrees | surface | |
| Example 4 | 20 | 10 | Good | 156 | Wet | |
| | mass % | mass % | | degrees | surface | |
| Comparative | 20 | 50 | Good | 155 | Water- | Excessive |
| Example 8 | mass % | mass % | | degrees | repellent | amount of fine |
| | | | | | surface | particles |
| | | | | | | added |

*The concentration of the spherical particles and the water-repellent resin
**The amount relative to the water-repellent resin

Examples 3 and 4 are films containing fine particles. In Example 3, suited properties are obtained although the coating liquid has a low concentration as in Comparative Example 6. In Example 4, the coating film has both good super water-repellency and good hydrophilicity.

In Comparative Examples 6 and 7, the coating liquid has concentrations different from that in Example 1. Spray coating was performed to form a uniform wet surface. In Comparative Example 6, the coating film is not super water-repellent, and is not hydrophilic after spraying the water 6. This is because the coating liquid is so thin that the liquid flows until drying and the protrusions 8 are not uniformly formed. In Comparative Example 7, the concentration of the coating liquid is too high. The surface roughness of the coating film 10 was so large that no distinct protrusions 8 were formed, and the coating film 10 exhibited uneven super water-repellency and uneven hydrophilicity after spraying the water 6. In Comparative Example 8, the amount of the fine particles added is too large, and the water-repellent resin 2 itself has a contact angle of 135 degrees. The coating film is not hydrophilic even after spraying the water 6.

### Example 5 and Comparative Examples 9 and 10

In Example 5, the test was carried out by preparing a coating liquid having the same concentration as in Example 1 by use of the water-repellent resin 2 and fused silica FB5D (average particle size 5 μm, available from Denka Company Limited) as the spherical particles 3. A fluororesin (Obbligato SS0054, AGC COAT-TECH Co., Ltd.) was used as the water-repellent resin 2 of Example 5. An urethane dispersion (HUX-840, ADEKA Corporation) was used as the water-repellent resin 2 of Comparative Example 9. A fluororesin coating agent (NOXBARRIER ST-462, Unimatec Co., Ltd.) was used as the water-repellent resin 2 of Comparative Example 10.

TABLE 3

| | Contact | | | | |
|---|---|---|---|---|---|
| | Angle of | | | | |
| | Water- | | | After | |
| | Repellent | Shape of | Contact | Spraying | |
| | Resin | Protrusions | Angle | Water | Note |
| Example 5 | 96 | Good | 148 | Wet | Liquid |
| | degrees | | degrees | surface | with low |
| | | | | | concentration |
| Comparative | 67 | Good | 50 | Wet | Wet surface |
| Example 9 | degrees | | degrees | surface | with water |
| | | | | | repellency |
| | | | | | Excessively |
| | | | | | small resin |
| | | | | | contact angle |
| Comparative | 115 | Good | 158 | Water- | Water- |
| Example 10 | degrees | | degrees | repellent | repellent |
| | | | | surface | resin |
| | | | | | Excessively |
| | | | | | large |
| | | | | | contact angle |

In Example 5, the water-repellent resin 2 has appropriate water-repellency, and the coating film has both super water-repellency and hydrophilicity as in Example 1. In Comparative Example 9, the water-repellent resin 2 has insufficient water repellency, and the coating film has no super water-repellency. In Comparative Example 10, the water-repellent resin 2 has excessively high water repellency, and the coating film is not hydrophilic after spraying the water 6.

### (Cleaning Effect)

### Examples 6 to 9 and Comparative Examples 11 to 14

The coating films 10 formed in Examples 1 and 5 and Comparative Examples 3 and 10 were contaminated with dust and oi and then subjected to the washing test. The dust-contaminated conditions were prepared by sprinkling Kanto loam powder (JIS Test Powder 1-11) on the coating film and lightly wiping the powder with a nonwoven fabric. The oil-contaminated conditions were prepared by exposing the coating films to oil smoke generated by heating salad oil. The coating films were washed by spraying the water 6 from a pump sprayer.

TABLE 4

| | | After | After | Contact |
|---|---|---|---|---|
| | | Contamination | Spraying | Angle After |
| | Coating Film | with Dust | Water | Spraying Water |
| Example 6 | Example 1 | Dust adhered | Cleaned | 151 degrees |
| | | | | (initial value |
| | | | | recovered) |
| Example 7 | Example 5 | Dust adhered | Cleaned | 147 degrees |
| | | | | (initial value |
| | | | | recovered) |
| Comparative | Comparative | Dust adhered | Dust | 130 degrees |
| Example 11 | Example 3 | | residue | (degraded) |
| Comparative | Comparative | Dust adhered | Dust | 110 degrees |
| Example 12 | Example 10 | | residue | (degraded) |

Table 4 shows the results of dust contamination and subsequent washing. All of the coating films 10 were contaminated with fine dust by rubbing the coating films 10 with fine dust. In Examples 6 and 7, dust was removed by spraying the water 6, and the initial super water repellency was recovered by drying the coating films after removing dust, which indicates that the coating films have high cleaning performance while having super water-repellency. In Comparative Examples 11 and 12, dust remains after spraying the water 6, and the initial super water-repellency is lost after drying.

TABLE 5

| | | After | After | After Spraying | |
|---|---|---|---|---|---|
| | | Contamination | Spraying | Detergent | Contact Angle |
| | Coating Film | with Oil | Water | Water | After Washing |
| Example 8 | Example 1 | Oil attached | No change | Cleaned | 150 degrees |
| | | | | | (initial value) |
| Example 9 | Example 5 | Oil attached | No change | Cleaned | 147 degrees |
| | | | | | (initial value) |
| Comparative | Comparative | Oil attached | No change | Partial residue | 76 degrees |
| Example 13 | Example 3 | | | | (degraded) |
| Comparative | Comparative | Oil attached | Oil partially | Residue | 90 degrees |
| Example 14 | Example 10 | | released | | (degraded) |

Table 5 shows the results of oil contamination and subsequent washing. The oil attachment can be visually observed on all of the coating films 10. It is difficult to remove oil even by spraying the water 6. As a result of spraying the water 6 containing a dishwashing detergent, oil was removed in Examples 8 and 9. Furthermore, the initial super water-repellency was recovered by washing the coating films with the water 6 containing no detergent and drying the coating films, which indicates that the coating films have high cleaning performance against oil contamination. In Comparative Examples 13 and 14, oil remains even after spraying the water 6 containing a detergent, and the initial super water-repellency is not recovered even after washing with the water 6.

### (Snow Melting Effect)

### Examples 10 and 11 and Comparative Examples 15 to 17

The coating films 10 formed in Examples 1 and 5 and Comparative Examples 3 and 10 were evaluated for the snow melting effect. Each coating film 10 was formed on an aluminum plate with a thickness of 1 mm, and the resulting plate was horizontally placed on an electric griddle and heated. Ten grams of ice shaved with a shaved ice machine was formed into a cylindrical shape with a diameter of 3 cm and used as artificial snow for evaluating snow melting. The artificial snow was placed on each coating film 10, and the time to complete melting was compared.

TABLE 6

| | Coating Film | 40 degrees C. | 60 degrees C. | 80 degrees C. |
|---|---|---|---|---|
| Example 10 | Example 1 | 320 seconds | 190 seconds | 150 seconds |
| Example 11 | Example 5 | 320 seconds | 190 seconds | 200 seconds |
| Comparative | Comparative | 320 seconds | 250 seconds | 200 seconds |
| Example 15 | Example 3 | | | |
| Comparative | Comparative | 330 seconds | 280 seconds | 210 seconds |
| Example 16 | Example 10 | | | |
| Comparative | None | 280 seconds | 180 seconds | 140 seconds |
| Example 17 | | | | |

Table 6 shows the comparison of the snow melting time. In Examples 10 and 11, the snow melting time is almost the same, and there is an effect in which the water 6 comes into contact with the surface of the coating film 10 as the temperature increases. The coating films 10 have super water-repellency at low temperature to prevent or reduce attachment of snow, and has a snow melting effect when the coating films 10 are heated. At 60 degrees C. and 80 degrees C., Comparative Examples 15 and 16 show a longer snow melting time than the aluminum plate. Comparative Example 17 is an aluminum plate without the coating film 10.

### (Antibacterial Effect)

### Examples 12 and 13 and Comparative Examples 18 to 21

An antibacterial agent was added to the compositions of Example 1 and Comparative Examples 2 and 3 in an amount corresponding to 0.1 mass % of the water-repellent resin 2. The antibacterial agent was mixed with a coating liquid, and the coating liquid was applied and dried to form the coating film 10. Since a very small amount of the antibacterial agent was added, the antibacterial agent had no effect on water repellency and hydrophilicity. Silver nanoparticles were used as an inorganic antibacterial agent, or diiodomethyl-p-tolyl sulfone was used as an organic antibacterial agent. Antibacterial activity was evaluated on the basis of the effect on Staphylococcus aureus in Z2801: 2010. The evaluation was carried out by use of samples sprayed with the water 6, where samples capable of becoming hydrophilic were in a hydrophilic state, and samples incapable of becoming hydrophilic were in a water-repellent state.

TABLE 7

| | Composition | | Antibacterial |
|---|---|---|---|
| | of Coating | Antibacterial | Activity |
| | Film | Agent | Value |
| Example 12 | Example 1 | Silver | 4.5 |
| | | nanoparticles | |
| Comparative | Comparative | Silver | 2.3 |
| Example 18 | Example 2 | nanoparticles | |
| Comparative | Comparative | Silver | 1.9 |
| Example 19 | Example 3 | nanoparticles | |
| Example 13 | Example 1 | Organic agent | 5.8 |
| Comparative | Comparative | Organic agent | 1.9 |
| Example 20 | Example 2 | | |
| Comparative | Comparative | Organic agent | 2.5 |
| Example 21 | Example 3 | | |

*Organic agent: diiodomethyl-p-tolyl sulfone

In Examples 12 and 13, the antibacterial activity is high. In Comparative Examples 18 to 21, the antibacterial activity is obtained but lower than that in Examples 12 and 13. Although the material compositions are the same, there is a large difference in antibacterial activity. This is because the coating films 10 of Examples 12 and 13 turn hydrophilic and allow efficient sustained release of the antibacterial agent under excessive humid conditions required for antibacterial activity.

### (Use of Binding Agent 7)

### Examples 14 to 16 and Comparative Example 22

An undercoat layer was formed by use of a coating agent containing FB 15D (average particle size 15 μm, available from Denka Company Limited) as the spherical particles 3 and silicate (N-103X, COLCOAT CO., LTD.) as the binding agent 7. A solution of Lumiflon LF800 (available from AGC Inc.) in Mineral Spirits was applied as an overcoat agent. To evaluate the film strength, the contact angle after 10 reciprocations of rubbing with a rayon nonwoven fabric at a pressure of 80 g/cm² was measured.

TABLE 8

| | | | | | | | Contact |
|---|---|---|---|---|---|---|---|
| | | | | | | After | Angle |
| | Spherical | Binding | Overcoat | Shape of | Contact | Spraying | After |
| | Particles | Agent | Agent | Protrusions | Angle | Water | Abrasion |
| Example 14 | 1.5 | 1.5 | 2 | Good | 149 | Wet | 145 |
| | mass % | mass % | mass % | | degrees | surface | degrees |
| Example 15 | 3.0 | 1.5 | 2 | Good | 153 | Wet | 140 |
| | mass % | mass % | mass % | | degrees | surface | degrees |
| Example 16 | 0.5 | 1.5 | 2 | Good | 151 | Wet | 95 |
| | mass % | mass % | mass % | | degrees | surface | degrees |
| Comparative | 3.0 | 1.5 | 5 | Deficient | 95 | Water- | 90 |
| Example 22 | mass % | mass % | mass % | protrusion | degrees | repellent | degrees |
| | | | | formation | | surface | |

In Examples 14 to 16, super water-repellency and hydrophilicity after spraying the water 6 are obtained. In Examples 14 and 15, high super water-repellency is maintained after the abrasion test, which indicates that the binding agent 7 improves the strength of the coating film 10. In Example 16, the coating film is degraded by rubbing and fails to have enough film strength because of a small amount of the binding agent 7. In Comparative Example 22, the concentration of the overcoat agent is so high that the protrusions 8 formed by the undercoat layer are buried in the overcoat agent, and the coating film is not super water-repellent, and is not hydrophilic after spraying the water 6.

### REFERENCE SIGNS LIST

1: substrate, 2: water-repellent resin, 3: spherical particle, 4a, 4b: maximum portion, 5a, 5b: minimum portion, 6: water, 7: binding agent, 8: protrusion, 10: coating film, 20: component part

1. A coating film comprising a water-repellent resin having a smooth surface and a contact angle of 70 degrees or more,
the coating film having a plurality of protrusions formed by the water-repellent resin, the plurality of protrusions being scattered in the coating film and each having an end portion with a convex surface formed by cutting out a continuous region accounting for 50% or more of a spherical surface,
the spherical surfaces each having an average radius of curvature of 16 μm or less,
an average distance between each ones of the plurality of protrusions adjacent to each other being less than or equal to 30 times a radius of curvature,
the plurality of protrusions being formed by spherical particles each having an average particle size of 1 μm or more and 30 μm or less, the spherical particles being located inside the water-repellent resin, fine particles each having an average particle size of 10 nm or more and 200 nm or less being added,
a volume ratio of the spherical particles being 50% or more and 500% or less of the water-repellent resin,
the coating film being applied with a coating liquid containing 1.5 mass % or more and 30 mass % or less of the spherical particles and the water-repellent resin.

2. The coating film of claim 1,
wherein the spherical surfaces each have an average radius of curvature of 0.6 μm or more,
the average distance between each ones of the plurality of protrusions adjacent to each other is more than or equal to 4 times the radius of curvature, and
the water-repellent resin has a smooth surface and a contact angle of 110 degrees or less.

3. The coating film of claim 1,
wherein a horizontal cross-sectional area of each of the plurality of protrusions has a maximum possible value in the end portion that is a portion of the corresponding spherical surface.

4. (canceled)

5. The coating film of claim 1,
wherein the coating film is applied with a coating liquid containing 5 mass % or more and 40 mass % or less of the spherical particles and the water-repellent resin.

6. (canceled)

7. The coating film of claim 1,
wherein the spherical particles are adhered to each other by a binding agent, and
a volume ratio of the spherical particles is 80% or more and 600% or less of the binding agent.

8. The coating film of claim 1,
wherein the water-repellent resin has a smooth surface and a contact angle of 80 degrees or more.

9. A component part comprising:
a substrate; and
the coating film of claim 1 located on the substrate.
